(19) United States
(12) Patent Application Publication
(10) Pub. No.: US 2021/0062386 A1
(43) Pub. Date: Mar. 4, 2021

(54) CAVITATOR OF MICROBUBBLE GENERATOR, MICROBUBBLE GENERATOR AND WASHING DEVICE

(71) Applicant: WUXI LITTLE SWAN ELECTRIC CO., LTD., WUXI (CN)

(72) Inventors: Yuan GAO, WUXI (CN); Yongjian DENG, WUXI (CN); Ming XIONG, WUXI (CN)

(21) Appl. No.: 16/962,226

(22) PCT Filed: Jan. 25, 2019
(86) PCT No.: PCT/CN2019/073213

§ 371 Date: Jul. 15, 2020

(30) Foreign Application Priority Data
Nov. 21, 2018 (CN) 201811392471.6
Nov. 21, 2018 (CN) 201821926359.1
Jan. 15, 2019 (CN) 201910036304.6
Jan. 15, 2019 (CN) 201920069108.4

(51) Int. Cl. D06F 35/00; B01F 5/04; B01F 3/04

(52) U.S. Cl. CPC D06F 35/002; B01F 2003/04858; B01F 3/04503; B01F 5/0428

(57) ABSTRACT

A cavitator of a microbubble generator, the microbubble generator and a washing device. The cavitator has a cavitation inlet and a cavitation outlet, at least one Venturi channel extending from the cavitation inlet towards the cavitation outlet is defined in the cavitator, and in the water flow direction, each of the Venturi channels includes a tapered section, a venturi and a divergent section in sequence, an open area of the tapered section is decreased gradually in a direction from the cavitation inlet to the throat pipe, an open area of the divergent section is increased gradually in a direction from the throat pipe to the cavitation outlet, and the throat pipe has a diameter of 0.2 mm to 2.0 mm.

### CROSS-REFERENCES TO RELATED APPLICATIONS

The present application is a national phase of International Application No. PCT/CN2019/073213, filed on Jan. 25, 2019, which claims priority to Chinese Patent Application Serial No. 201811392471.6, filed on Nov. 21, 2018, Chinese Patent Application Serial No. 201821926359.1, filed on Nov. 21, 2018, Chinese Patent Application Serial No. 201910036304.6, filed on Jan. 15, 2019, and Chinese Patent Application Serial No. 201920069108.4, filed on Jan. 15, 2019, the entire contents of which are incorporated herein by reference herein.

### FIELD

The present disclosure relates to the field of washing treatment, and more particular, to a cavitator of a microbubble generator, the microbubble generator and a washing device.

### BACKGROUND

At present, a microbubble technology is mainly applied in the field of environment protection, and also in households, such as skin care, showers, a laundry washing device, or the like. Most of the current microbubble generators applied in the above-mentioned fields have complex structures, some are required to be provided with additional water pumps, and some are required to be controlled by a plurality of valves. Meanwhile, there are more restrictions on the way of feeding water, or the like, resulting in relatively high costs. A cavitator of the microbubble generator has a large volume and an unreasonable structure and is quite inconvenient to mount and manufacture.

### SUMMARY

The present disclosure seeks to solve at least one of the problems existing in a prior art. To this end, the present disclosure proposes a cavitator for a microbubble generator, which has a simple structure and a good bubble generating effect and is convenient to mount.

The present disclosure further seeks to propose a microbubble generator having the above-mentioned cavitator.

The present disclosure further seeks to propose a washing device having the above-mentioned microbubble generator.

A cavitator of a microbubble generator according to an embodiment of the present disclosure has a cavitation inlet and a cavitation outlet configured to allow water to flow in and out; at least one Venturi channel extending from the cavitation inlet towards the cavitation outlet is defined in the cavitator; in the water flow direction, each Venturi channel includes a tapered section, a throat pipe and a divergent section in sequence; an open area of the tapered section is decreased gradually in a direction from the cavitation inlet to the throat pipe, an open area of the divergent section is increased gradually in a direction from the throat pipe to the cavitation outlet, and the throat pipe has a diameter of 0.2 mm to 2.0 mm.

The cavitator according to the embodiment of the present disclosure has the Venturi channel, which on the one hand, guarantees the ability of generating bubbles of the cavitator, and on the other hand, is convenient to process the cavitator and easy to control the cost due to its simple structure. By limiting the diameter of the throat pipe to range from 0.2 mm to 2 mm, in which range the cavitator generates a large number of bubbles and has a moderate flow velocity, the cavitator has high practicability.

In some embodiments, the throat pipe has a diameter of 0.5 mm to 1.0 mm.

In some embodiments, a diverting groove and a converging groove are formed on two end surfaces of the cavitator respectively, an opening of the diverting groove is configured as the cavitation inlet, an opening of the converging groove is configured as the cavitation outlet, and the Venturi channel is formed between a bottom wall of the diverting groove and a bottom wall of the converging groove.

In some embodiments, a mounting section is formed at a first end of the cavitator.

In some embodiments, an abutting flanged ring is provided on an outer peripheral wall of the cavitator and close to the mounting section.

In some embodiments, an anti-off flanged ring configured to be connected with a hose is provided at an outer peripheral edge of a second end of the cavitator.

In some embodiments, the cavitation outlet has a diameter of 5 mm to 15 mm.

In some embodiments, a diameter of an end portion of the tapered section towards an end of the cavitation inlet is at least 1.05 times the diameter of the throat pipe.

In some embodiments, a diameter of an end portion of the divergent section towards an end of the cavitation outlet is at least 1.05 times the diameter of the throat pipe.

In some embodiments, a length of the tapered section is less than a length of the divergent section.

In some embodiments, the length of the divergent section is no more than four times the length of the tapered section.

In some embodiments, four to six Venturi channels are provided.

A microbubble generator according to an embodiment of the present disclosure includes an air dissolving tank and the cavitator according to the above embodiments of the present disclosure. The cavitator is provided outside the air dissolving tank and connected with a water outlet of the air dissolving tank, or is provided at the water outlet.

The microbubble generator according to the embodiment of the present disclosure has a good bubble generating effect. With the structure of the cavitator, one end of the cavitator can be mounted onto the air dissolving tank quite conveniently, and the other end of the cavitator can be provided with a pipe fitting or other components quite conveniently, along with a compact integral structure, and small occupied space.

Specifically, a filter device is provided between the air dissolving tank and the cavitator and is provided with at least one filter hole which has a diameter less than the diameter of the narrowest portion of the throat pipe.

A washing device according to an embodiment of the present disclosure includes the microbubble generator according to the above embodiments of the present disclosure.

In the washing device according to the embodiment of the present disclosure, with the delicate design of the microbubble generator, the structural characteristics of the cavitator enable the water flow into and out of the air dissolving tank to have a flow velocity difference, and the pressure in the air dissolving tank is increased gradually to form a high-pressure cavity, increasing the amount of dissolved air. The cavitator enables a high-concentration air solution to generate microbubbles rapidly, has a simple structure and is easy to mount. The above-mentioned microbubble generator omits a plurality of valves, and has a low cost and a good microbubble generating effect. Washing water contains a large number of microbubbles, which reduces the usage amount of washing powder or detergent, saves water and electricity resources, and reduces the residual washing powder or the detergent on clothes.

Additional aspects and advantages the present application will be given in part in the following descriptions, become apparent in part from the following descriptions, or be learned from the practice of the embodiments of the present disclosure.

### BRIEF DESCRIPTION OF THE DRAWINGS

The above-mentioned and/or additional aspects and advantages of the present disclosure will become apparent and more readily appreciated from the following descriptions of the embodiments made with reference to the drawings, in which

FIG. 1 is a schematic structural diagram of a microbubble generator according to an embodiment of the present disclosure.

FIG. 2 is a perspective view of a cavitator according to an embodiment of the present disclosure.

FIG. 3 is another perspective view of the cavitator shown in FIG. 2.

FIG. 4 is a schematic sectional diagram of the cavitator shown in FIG. 3.

FIG. 5 is a sectional view at an air dissolving tank in FIG. 1.

FIG. 6 is a comparison diagram of water generating results of the cavitator in each range of diameter of a throat pipe according to an embodiment.

FIG. 7 is a comparison diagram of water generating results of the cavitator in each range of a ratio of a diameter of an end portion of a tapered section to a diameter of the throat pipe according to an embodiment.

FIG. 8 is a comparison diagram of water generating results of the cavitator in each range of a ratio of a length of a divergent section to a length of the tapered section according to an embodiment.

### REFERENCE NUMERALS

Microbubble generator 100; air dissolving tank 1; air dissolving cavity 10; water inlet 11; water outlet 12;

cavitator 2; cavitation inlet 21; cavitation outlet 22; threaded section 231; abutting flanged ring 232; anti-off flanged ring 233; hexagonal flanged ring 234; Venturi channel 25; tapered section; throat pipe 252; divergent section 253; diverting groove 261; converging groove 262.

### DETAILED DESCRIPTION OF THE INVENTION

Reference will be made in detail to embodiments of the present application, and the examples of the embodiments are illustrated in the drawings, wherein the same or similar elements and the elements having same or similar functions are denoted by like reference numerals throughout the descriptions. The embodiments described herein with reference to drawings are illustrative, and merely used to explain the present application. The embodiments shall not be construed to limit the present application.

In the description of the present application, it is to be understood that terms such as “center”, “length”, “upper”, “lower”, “vertical”, “horizontal”, “top”, “bottom”, “inner”, “outer”, “clockwise”, “anticlockwise”, “axial”, “radial”, and “circumferential” should be construed to refer to the orientation as then described or as shown in the drawings under discussion. These relative terms are for convenience of description and do not require that the present application be constructed or operated in a particular orientation, thus cannot be construed to limit the present application.

In the description of the present disclosure, it should be noted that unless specified or limited otherwise, the terms “mounted”, “connected”, and “coupled” and the like are used broadly, and may be, for example, fixed connections, detachable connections, or integral connections; may also be mechanical connections; may also be direct connections or indirect connections via intervening structures; may also be inner communications of two elements. The above terms can be understood by those skilled in the art according to specific situations.

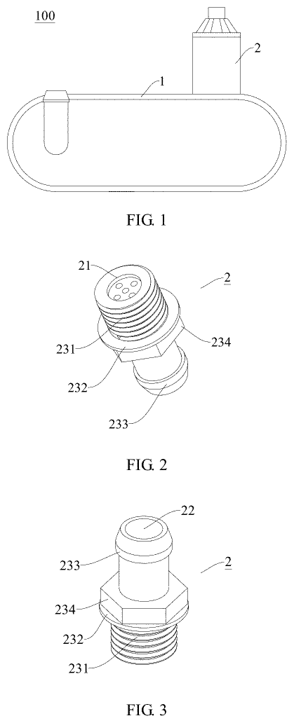

A cavitator 2 of a microbubble generator according to an embodiment of the present disclosure will be described below with reference to FIGS. 1 to 8.

When water containing a high-concentration air solute enters the cavitator 2, the cavitator 2 generates a microbubble using the cavitation effect. The water discharged out of the cavitator 2 contains a large number of microbubbles, and may be guided to where it is needed for washing and rinsing, for example, to a detergent box for dissolving a detergent rapidly, or to other components for other processes. The cavitator 2 may be used alone, and some microbubble generator 100 includes an air dissolving tank 1 and the cavitator 2. When the microbubble generator 100 is in use, water-soluble gas enters the air dissolving tank 1 to form an aqueous solution which contains the high-concentration air solute, and the cavitator 2 generates the microbubble in the aqueous solution discharged out of the air dissolving tank 1.

Referring to FIGS. 1 to 4, the cavitator 2 has a cavitation inlet 21 and a cavitation outlet 22 configured to feed and discharge water, at least one Venturi channel 25 which extends from the cavitation inlet 21 towards the cavitation outlet 22 is defined in the cavitator 2, and in the water flow direction, each of the Venturi channels 25 includes a tapered section 251, a throat pipe 252 and a divergent section 253 in sequence, an open area of the tapered section 251 is reduced gradually in a direction from the cavitation inlet 21 to the throat pipe 252, and an open area of the divergent section 253 is increased gradually in a direction from the throat pipe 252 to the cavitation outlet 22. That is, in each of the Venturi channels 25, the throat pipe 252 has the minimum open area. A sectional shape of the Venturi channel 25 is not defined herein, and may be circular to facilitate processing, but in other embodiments, may also be elliptical, or the like.

After flowing into the cavitation inlet 21, the large amount of fed water is unable to flow out smoothly through the Venturi channel 25, and a great pressure difference is formed between two ends of the Venturi channel 25, with a large pressure at the cavitation inlet 21, and a small pressure at the cavitation outlet 22.

The water flow entering from the cavitation inlet 21 is distributed into the at least one Venturi channel 25. That is, the water flow with a large section is crushed into the Venturi channel 25 with a small section, and a flow velocity of the water driven by a high pressure to enter the Venturi channel 25 will increase rapidly. In each of the Venturi channels 25, the water flows firstly through the tapered section 251 with the open area reduced gradually, then through the divergent section 253 with the open area increased gradually, and the flow velocity and pressure of the water change therewith. In the process of the change in the pressure of the water, a solubility of air in the water will be reduced in the Venturi channel 25, precipitating the air in the form of microbubbles.

The relevant principles of the cavitation effect are as follows.

An average speed, an average pressure, and a sectional area at an input end of the tapered section 251 are V1, P1, and S1 respectively, and the average speed, average pressure, and sectional area at the throat pipe 252 are V2, P2, and S2 respectively. A water density is ρ. In the operating state, it is assumed that tap water is taken as a working medium, satisfying the relationship: S1*V1=S2*V2.

With Bernoulli's law and a continuity equation, the following relational expression may be obtained: V1²/2+P1/ρ=V2²/2+P2/ρ.

In this process, by controlling the changes in S1 and S2, in the Venturi channel 25, the flow velocity at the throat pipe 252 increases and the pressure at the throat pipe 252 decreases, thus the air dissolved in the water is released in the form of microbubbles.

In the embodiment of the present disclosure, the throat pipe 252 is located at a position with a minimum size in the Venturi channel 25, and the size is the key to the bubble generating effect of the Venturi channel 25.

The applicant finds that when the throat pipe 252 has a diameter d1 less than 0.2 mm, under a common water pressure (about 0.15 to 0.30 MPa) of the water fed into a washing device, the cavitator 2 has an excessively low rate of flow of the discharged water, which is unable to meet a washing demand. Meanwhile, a risk of blockage exists due to a tiny substance, such as silt, rust, or the like, carried in the tap water, and the throat pipe 252 has the diameter d1 which is too small to facilitate mass production by a mold, since an injection molded workpiece is not easily molded at a small via hole, resulting in hole stoppage.

When the throat pipe 252 has the diameter d1 of 0.2 mm to 2.0 mm, the cavitator 2 is easy to process. Meanwhile, under the common water pressure of washing equipment, the cavitator 2 generates more microbubbles, and the water flows through the cavitator 2 at a moderate flow velocity, a working condition is ideal in the cavitator 2 with the diameter d1 of the throat pipe 252 defined from 0.2 mm to 2.0 mm. When the throat pipe 252 has the diameter d1 greater than 2.0 mm, the cavitator 2 generates a less number of microbubbles. Thus, after overall consideration, in the cavitator 2 according to the present disclosure, the throat pipe 252 has the diameter d1 selected from 0.2 mm to 2.0 mm.

In one embodiment, the throat pipe 252 has the diameter d1 of 0.5 mm to 1.5 mm, in which range, the cavitator 2 generates more microbubbles, and the water flows through the cavitator 2 at a more moderate velocity, which is quite suitable for the actual use of the washing device.

A change in the diameter from the tapered section 251 to the throat pipe 252 may also affect the effect of generating the bubbles by influencing the flow velocity and the change in pressure of the water. Thus, In one embodiment, the diameter d2 of the end portion of the tapered section 251 towards one end of the cavitation inlet 21 is at least 1.05 times the diameter d1 of the throat pipe 252, and further In one embodiment, the diameter d3 of the end portion of the tapered section 251 towards one end of the cavitation inlet 21 is at least 1.3 times the diameter d1 of the throat pipe 252.

Similarly, a change in diameter from the throat pipe 252 to the divergent section 253 may also affect the effect of generating the bubbles by influencing the flow velocity and the change in pressure of the water. Thus, In one embodiment, the diameter d3 of the end portion of the divergent section 253 towards one end of the cavitation outlet 22 is at least 1.05 times the diameter d1 of the throat pipe 252, and further In one embodiment, the diameter d3 of the end portion of the divergent section 253 towards one end of the cavitation outlet 22 is at least 1.3 times the diameter d1 of the throat pipe 252.

In one embodiment, the cavitator 2 has a plurality of Venturi channels 25, which on the one hand, guarantees an ability of generating bubbles of the cavitator, and on the other hand, is convenient to process the cavitator and easy to control the cost due to its simple structure.

In addition, the cavitator 2 is cylindrical and quite convenient to mount, and extra fitting structures and sealing structures are omitted when the cavitator 2 is mounted onto the microbubble generator 100, facilitating reduction of the occupied volume of the microbubble generator 100. With the cavitator 2 according to the embodiment of the present disclosure, additional water pump, heating device or control valve, or the like are not required, and no additional requirement is placed on the way of water admission of the microbubble generator 100.

Certainly, the cavitator 2 of the microbubble generator according to the embodiment of the present disclosure is not limited to the cylindrical shape, and for example, may further be formed into an L shape, an S shape, or the like according to actual mounting requirements.

Specifically, a length of the Venturi channel 25 is greater than the diameter of the cavitator 2, and the Venturi channel 25 is lengthened, which contributes to the adequate Venturi effect.

In some embodiments, as shown in FIGS. 2 to 4, a diverting groove 261 and a converging groove 262 are formed on two end surfaces of the cavitator 2 respectively, an opening of the diverting groove 261 is configured as the cavitation inlet 21, an opening of the converging groove 262 is configured as the cavitation outlet 22, and at least one Venturi channel 25 is formed between a bottom wall of the diverting groove 261 and a bottom wall of the converging groove 262. Herein, in the process that the water flows to the Venturi channel 25 from the diverting groove 261, the water entering the Venturi channel 25 is accelerated in advance, reaching an ideal velocity and an ideal pressure after entering the Venturi channel 25. Similarly, in the process that the water flows to the converging groove 262 from the Venturi channel 25, the water flow is slowed down, the microbubble which is formed newly gets into a stable state temporarily and prevented from being broken too early.

Herein, the diverting groove 261 and the converging groove 262 are provided on the cavitator 2, which facilitates processing and manufacturing. In addition, the cavitator 2 is mounted at various positions, and in order to be adapted to different mounting structures, the cavitator 2 is provided with the diverting groove 261 and the converging groove 262, the cavitator 2 has a pre-accelerated flow period section and a flow period during which the microbubbles are stable under any mounting condition.

Specifically, a mounting section is formed at one end of the cavitator 2 and configured to be mounted on the air dissolving tank 1. For example, as shown in FIG. 2, in order to facilitate mounting, the mounting section is a threaded section 231 which may be configured as internal thread or external thread. In an example of FIG. 1, the threaded section 231 of the cavitator 2 at one end connected with the air dissolving tank 1 is configured as the external thread, and screwed onto the air dissolving tank 1 very conveniently.

In one embodiment, the mounting section may include a plurality of layers of retainer rings which are formed on an inner surface or an outer surface of the cavitator 2, and a seal ring may be provided between the adjacent retainer rings, good sealing connection may be formed when the cavitator 2 is connected onto the air dissolving tank 1 through the mounting section.

Specifically, as shown in FIGS. 2 to 3, the threaded section 231 is formed on a peripheral wall of the cavitator 2, and an abutting flanged ring 232 is provided on the peripheral wall of the cavitator 2 close to the threaded section 231. The arrangement of the abutting flanged ring 232, on the one hand, forms positioning, and on the other hand, facilitates seal.

In one embodiment, as shown in FIGS. 2 to 3, a hexagonal flanged ring 232 is provided on the peripheral wall of the cavitator 2, and has a hexagonal outer contour, and the cavitator 2 may be screwed onto the hexagonal flanged ring 234 with a tool, such as a wrench, or the like.

In one embodiment, as shown in FIGS. 2 to 3, an anti-off flanged ring 233 configured to be connected with a hose is provided at an peripheral edge of the other end of the cavitator 2. The connection through a hose is quite convenient, and the arrangement of the anti-off flanged ring 233 may prevent the hose from being separated from the cavitator 2. In order to further enhance connection reliability, a tension band, an iron wire, or the like may be fitted over the outer side of the hose. The structure, such as the tension band, the iron wire, or the like, is located on one side of the anti-off flanged ring 233 after clamped, the hose is not prone to be separated. Further In one embodiment, as shown in FIG. 3, an end surface of the anti-off flanged ring 233 towards the cavitation outlet 22 is formed as a conical surface, conveniently mounting the hose.

Generally, the cavitator 2 is connected into other components through a pipeline, an inner diameter of an outlet end of the cavitator 2 may be selected to range from 5 mm to 15 mm. That is, the cavitation outlet 22 has a diameter of 5 mm to 15 mm. Further In one embodiment, the diameter of the cavitation outlet 22 is controlled to range from 7 mm to 10 mm. In one embodiment, 1 to 30 Venturi channel(s) is/are provided, and further In one embodiment, 4 to 6 Venturi channels are provided. In the washing device, as a key component, the cavitator 2 is required to treat the water inflow of the washing device, and the incoming water to the washing device is generally domestic tap water. The flow velocity of the domestic tap water is generally 5-12 L/min, and the water pressure is generally 0.02-1 Mpa. More commonly, the flow velocity is generally 8-10 L/min, and the water pressure is generally 0.15-0.3 Mpa. Therefore, four to six Venturi channels 25 may be provided in the cavitator 2. Thus, the water flow distributed in each of the Venturi channels 25 may reach the maximum bubble generating effect exactly.

Ideally, as a diffusion section, the divergent section 253 enables a fluid to be decelerated gradually, and thus a certain length thereof is required.

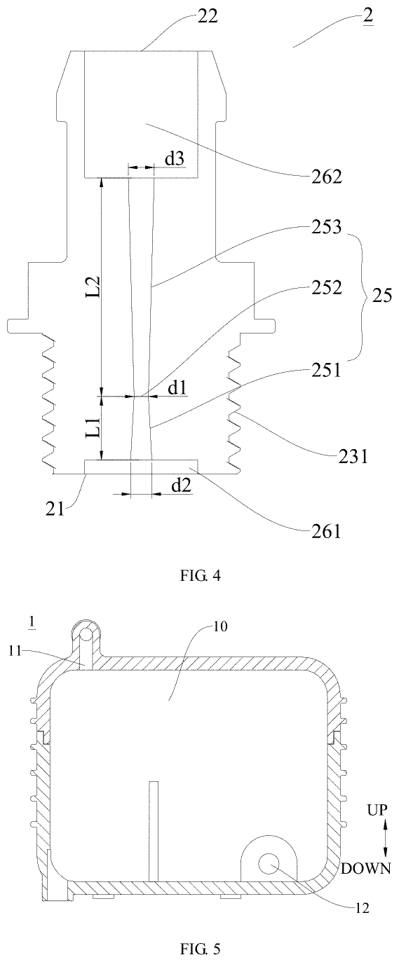

In one embodiment, as shown in FIG. 4, the length L2 of the divergent section 253 is greater than the length L1 of the tapered section 251, and further In one embodiment, the length L2 of the divergent section 253 is no more than four times the length L1 of the tapered section 251, i.e., a ratio of L2 to L1 is greater than 1 and less than 4.

In conclusion, the cavitator 2 according to the embodiment of the present disclosure has a small and exquisite structure and a simple model, is convenient to process and mount, and has a high practicability.

The present disclosure will be described below with reference the embodiments, and it should be noted that the embodiments are merely descriptive, without limiting the present disclosure in any way.

### Embodiment 1

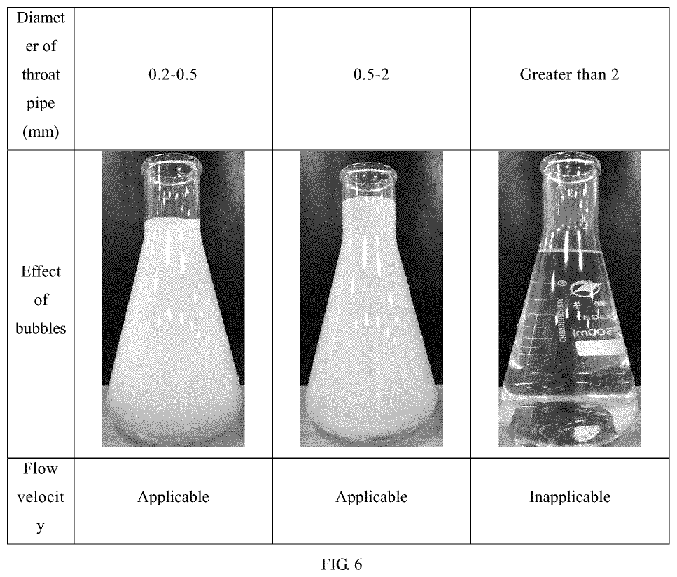

As shown in FIG. 6, on a premise of the same structure, a change is made to the diameter d1 of the throat pipe 252 of the cavitator 2, and the cavitator 2 obtains different kinds of microbubble water in various parameter selection ranges. When the diameter d1 of the throat pipe 252 is selected to range from 0.2 mm to 0.5 mm, the water changes from a transparent color to a strong milk white, from which it may be inferred that the microbubble has a high content in the water. When the diameter d1 of the throat pipe 252 is selected to range from 0.5 mm to 2 mm, the water keeps the strong milk white. Thus, it may be concluded that the microbubble still has a high content in the water, and in this range, the cavitator 2 has a suitable water flow velocity. When the diameter d1 of the throat pipe 252 is selected to be less than 0.2 mm, the water flows through the cavitator 2 at an excessively small flow velocity, which is inapplicable any more. When the diameter d1 of the throat pipe 252 is selected to be greater than 2 mm, the water contains the negligible microbubble, which is also inapplicable any more.

### Embodiment 2

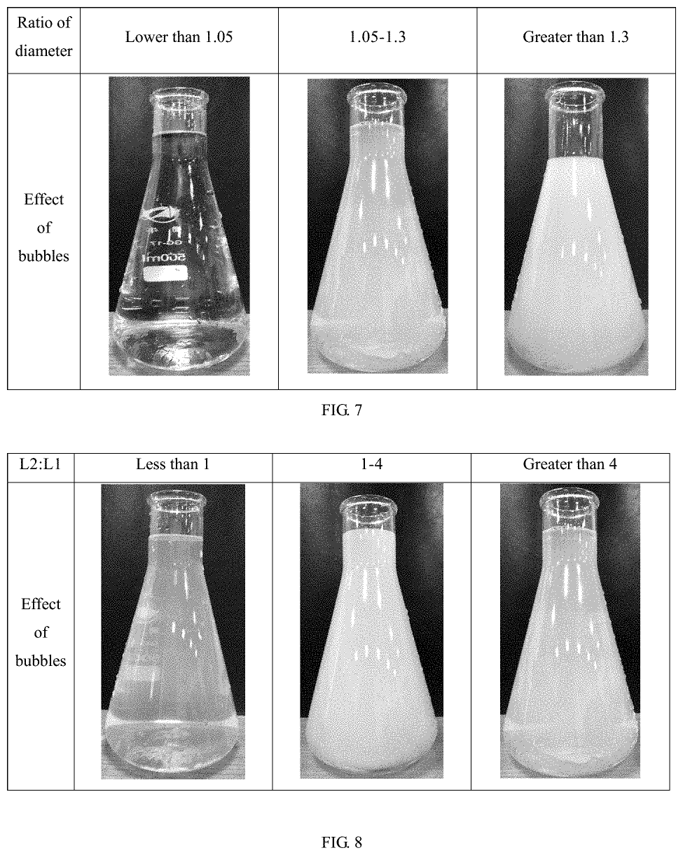

As shown in FIG. 7, on a premise of the same structure, a change is made to the ratio of the diameter d2 of the end portion of the tapered section 251 to the diameter d1 of the throat pipe 252 in the cavitator 2, and an experiment finds that the microbubble content in the water produced by the cavitator 2 is different under the condition of different ratios. When the ratio of the diameter d2 of the end portion of the tapered section 251 to the diameter d1 of the throat pipe 252 is lower than 1.05, the generated water is clear, which may be inferred obviously that the water has an excessively low microbubble content. When the ratio of the diameter ranges from 1.05 to 1.3, it may be concluded that the generated water has an obviously increased microbubble content from the color. Particularly, when the ratio of the diameter is greater than 1.3, the generated water has a color of strong milk white, which indicates that the water has a quite high microbubble content.

On the premise of the same structure, a similar experimental result may also be obtained by changing the ratio of the diameters d3, of the end portion of the divergent section 253 to the diameter d1 of the throat pipe 252 in the cavitator 2, which is not repeated herein.

### Embodiment 3

As shown in FIG. 8, the cavitator 2 is changed on the premise of the same structure, and it may be seen that when a change is made to the ratio of the lengths L2 of the divergent section 253 to the length L1 of the tapered section 251, the bubble generating effect will also be changed obviously.

After the bubble is generated at the throat pipe 252, when the divergent section 253 has a great change in gradient, the generated bubble is quite prone to be broken, when a length ratio of the divergent section 253 to the tapered section 251 is less than or even equal to 1:1, a large number of bubbles are broken immediately after generated, and thus the generated water does not have a high bubble concentration. When the length ratio of the divergent section 253 to the tapered section 251 is between 1 and 4, the generated water has a color of strong milk white, and has a quite high bubble content. When the length ratio of the divergent section 253 to the tapered section 251 is greater than 4, since the cavitator 2 has a relatively limited total length, the length of the tapered section 251 is relatively insufficient, the concentration of the bubble begins to be reduced. Thus, the divergent section 253 and the tapered section 251 have an optimal length ratio of 1 to 4.

As shown in FIGS. 1 and 5, the microbubble generator according to the embodiment of the present disclosure includes the air dissolving tank 1 and the cavitator 2 of the microbubble generator according to the above-mentioned embodiment of the present disclosure, an air dissolving cavity 10 is defined in the air dissolving tank 1 which is provided with a water inlet 11 and a water outlet 12, and the cavitator 2 is provided outside the air dissolving tank 1 and connected with the water outlet 12 of the air dissolving tank 1 or provided at the water outlet 12.

Due to structural characteristics of the cavitator 2, water discharging is slower than water feeding in the air dissolving tank 1, the upper cavity of the air dissolving cavity 10 forms a high-pressure cavity rapidly. Therefore, a dissolvability of the air in the high-pressure state is greater than a dissolvability thereof in the low-pressure state, and a large amount of air is dissolved in the water flowing into the cavitator 2, the cavitator 2 may produce a large number of microbubbles.

It should be noted that air is insoluble with respect to water. A percentage of the amount of air dissolved in water and the introduced amount of air is called as an air dissolving efficiency. The air dissolving efficiency is related to temperature, an air dissolving pressure, and a dynamic contact area of air and liquid phases. The method of changing the water temperature or air temperature is difficult to implement. The common method for improving the air dissolving efficiency is to use a booster pump to pressurize the air dissolving cavity 10, but various valves are required to be provided, so the cost of providing the booster pump is too high.

In the prior art, there is also a solution in which double inlets are provided in the air dissolving device, one inlet configured to introduce water, and the other inlet configured to introduce air at the same time of water admission. In order to inject air into flowing water, the booster pump is required to press the air into the water. In this solution, since the air inlet is located below the cavitator, the incoming bubbles will quickly flow toward the cavitator and be squeezed out. No space is available in the air dissolving tank for the bubbles to dissolve slowly, and the air dissolving effect is not ideal. The method of injecting air into the water by pressurizing is equivalent to directly pressing large bubbles into the water. Such large bubbles stay in water for a short period of time and are dissolved insufficiently. Even when passing through the cavitator, the large bubbles are squeezed into more small bubbles by the cavitator, but the small bubbles are millimeter-sized or greater, and will be quickly broken and released.

It should be emphasized that in the embodiment of the present disclosure, it is proposed that the air-dissolving tank 1 dissolves air in water, which means that air is taken as a solute and dissolved in water, i.e., air is dispersed in water molecules in the form of molecules or molecular groups. Air molecules are dispersed in a state that air is dissolved, and the air molecules in water molecules are relatively uniform. Afterwards, most of the bubbles precipitated by the cavitation effect only have a size of nanometers and micrometers at the beginning of formation. This is the desired microbubble produced by the microbubble generator 100. After the water with microbubbles flows to a final place for use, the microbubbles are dissolved with each other, and most of the obtained microbubbles may still be kept to be millimeter-sized or even less, with the best effect and its blasting energy effectively conveyed to between millimeter-sized and micrometer-sized fibers and detergent particles.

Moreover, in the case of the air bubbles forcibly injected into the water, the time of bubble breakage is too short to participate in the entire washing process. In the embodiment of the present disclosure, the air dissolved into the water is equivalent to a solute which takes time to precipitate water, and thus the air in the water may not be completely precipitated immediately when the water discharged out of the air dissolving tank 1 enters the cavitator 2. The microbubbles generated by the cavitator 2 may participate in a laundry treatment process immediately, and the air in the water will be precipitated continuously in the treatment process, supplementing the microbubbles; the newly supplemented microbubbles may participate in the laundry treatment process continuously, the microbubble participates in the whole laundry treatment process, improving the washing and rinsing abilities of the washing device.

Such a microbubble generator 100 generates the microbubbles with a relatively simple structure, dispensing with a plurality of valves.

Specifically, a filter device (not shown) is provided between the air dissolving tank 1 and the cavitator 2 and provided with at least one filter hole which has a diameter less than the diameter of the narrowest portion of the throat pipe 252. With such an arrangement, the water fed into the cavitator 2 may be filtered in advance, and the Venturi channel 25 is prevented from being blocked by tiny impurities.

A washing device according to an embodiment of the present disclosure includes the microbubble generator 100 according to the above-mentioned embodiment of the present disclosure, and the structure of microbubble generator 100 is not described herein.

A washing device according to an embodiment of the present disclosure includes the microbubble generator according to the above-mentioned embodiment of the present disclosure.

In the washing device according to the embodiment of the present disclosure, with the delicate design of the microbubble generator 100, the structural characteristics of the cavitator 2 enable the water fed into and discharged out of the air dissolving tank 1 to have a flow velocity difference, a pressure in the air dissolving tank 1 is increased gradually to form a high-pressure cavity, increasing an amount of dissolved air. The cavitator 2 enables a high-concentration air solution to generate microbubbles rapidly, has a simple structure and is easy to mount. The above-mentioned microbubble generator 100 dispenses with a plurality of valves, and has a low cost and a good microbubble generating effect. Washing water contains a large number of microbubbles, which reduces the usage amount of washing powder or detergent, saves water and electricity resources, and reduces the residual washing powder or the detergent on a laundry. Other components of the washing device according to the embodiment of the present disclosure, such as a motor, a reducer, a discharge pump, or the like, have structures and operations well known to persons skilled in the art, and are not described in detail herein.

In the description of the present specification, reference throughout this specification to “embodiment”, “example”, or the like means that a particular feature, structure, material, or characteristic described in connection with the embodiment or example is included in at least one embodiment or example of the present disclosure. In the specification, the schematic expressions to the above-mentioned terms are not necessarily referring to the same embodiment or example. Furthermore, the described particular features, structures, materials, or characteristics may be combined in any suitable manner in one or more embodiments or examples.

Although embodiments of the present disclosure have been shown and illustrated, it shall be understood by those skilled in the art that various changes, modifications, alternatives and variants without departing from the principle and idea of the present disclosure are acceptable. The scope of the present application is defined by the claims and its equivalents.

1. A cavitator for a microbubble generator, wherein
the cavitator has a cavitation inlet and a cavitation outlet configured to allow water to flow in and out,
at least one Venturi channel is defined in the cavitator,
the Venturi channel extends from the cavitation inlet towards the cavitation outlet,
in a water flow direction, each Venturi channel comprises: a tapered section, a throat pipe and a divergent section in sequence,
an open area of the tapered section is decreased gradually in a direction from the cavitation inlet to the throat pipe,
an open area of the divergent section is increased gradually in a direction from the throat pipe to the cavitation outlet, and
the throat pipe has a diameter of 0.2 mm to 1.0 mm.

2. The cavitator according to claim 1, wherein the throat pipe has a diameter of 0.5 mm to 1.0 mm.

3. The cavitator according to claim 1, wherein
a diverting groove and a converging groove are formed on two end surfaces of the cavitator respectively,
an opening of the diverting groove is configured as the cavitation inlet,
an opening of the converging groove is configured as the cavitation outlet, and
the Venturi channel is formed between a bottom wall of the diverting groove and a bottom wall of the converging groove.

4. The cavitator according to claim 3, wherein a mounting section is formed at a first end of the cavitator.

5. The cavitator according to claim 4, wherein an abutting flanged ring is provided on an outer peripheral wall of the cavitator and close to the mounting section.

6. The cavitator according to claim 4, wherein an anti-off flanged ring configured to be connected with a hose is provided at an outer peripheral edge of a second end of the cavitator.

7. The cavitator according to claim 1, wherein the cavitation outlet has a diameter of 5 mm to 15 mm.

8. The cavitator according to claim 1, wherein a diameter of an end portion of the tapered section towards an end of the cavitation inlet is at least 1.05 times the diameter of the throat pipe.

9. The cavitator according to claim 1, wherein a diameter of an end portion of the divergent section towards an end of the cavitation outlet is at least 1.05 times the diameter of the throat pipe.

10. The cavitator according to claim 1, wherein the tapered section has a length less than a length of the divergent section.

11. The cavitator according to claim 10, wherein the length of the divergent section is no more than four times the length of the tapered section.

12. The cavitator according to claim 1, wherein four to six Venturi channels are provided.

13. A microbubble generator, comprising:
an air dissolving tank, and a cavitator for a microbubble generator according to claim 1,
wherein the cavitator is provided outside the air dissolving tank and connected with a water outlet of the air dissolving tank,
or the cavitator is provided at the water outlet.

14. The microbubble generator according to claim 13, wherein,
a filter device is provided between the air dissolving tank and the cavitator,
the filter device is provided with at least one filter hole, and
the filter hole has a diameter less than the diameter of the narrowest portion of the throat pipe.

15. A washing device, comprising a microbubble generator according to claim 13.
